(19) United States
(12) Patent Application Publication
(10) Pub. No.: US 2025/0239954 A1
(43) Pub. Date: Jul. 24, 2025

(54) ROTATION CONTROL METHOD, DEVICE, AND COMPUTER STORAGE MEDIUM

(71) Applicant: TILTA INC., Burbank, CA (US)

(72) Inventors: Yiling WANG, Shenzhen (CN); Wenping ZENG, Shenzhen (CN); Kefeng ZHOU, Shenzhen (CN)

(21) Appl. No.: 19/032,704

(22) Filed: Jan. 21, 2025

(30) Foreign Application Priority Data
Jan. 22, 2024 (CN) 2024100889353

(51) Int. Cl. H02P 25/032; G06F 3/01; G06F 3/0362

(52) U.S. Cl. CPC H02P 25/032; G06F 3/016; G06F 3/0362

(57) ABSTRACT

A rotation control method, device, and computer storage medium are disclosed. The method is applicable to a rotation control device designed to drive a first component and a second component to rotate relative to each other. The method encompasses the following steps: identifying the relative rotation angle between the first component and the second component; and determining the angle range for the identified rotation angle. Notably, the first component and the second component are operable to rotate relative to each other within multiple preset angle ranges. As the rotation angle varies within a specific range, the damping between the first component and the second component is controlled to change correspondingly, thereby simulating diverse usage feels for the user.

### CROSS-REFERENCE TO RELATED APPLICATIONS

The present application for patent claims priority to and the benefit of pending Chinese Application No. 2024100889353, filed Jan. 22, 2024, and hereby expressly incorporated by reference herein as if fully set forth below in its entirety and for all applicable purposes.

### TECHNICAL FIELD

The present disclosure pertains to the realm of rotation control technology, particularly addressing a rotation control method, device, and computer storage medium.

### INTRODUCTION

Currently, within the smart device industry, numerous devices incorporate a first component and a second component capable of relative rotation, exemplified by the linkage between robotic arms or knobs on smart devices used for controlling movements. Using knobs as an illustration, the tactile feedback experienced by users when turning these knobs is often monotonous, thereby compromising user experience.

In prior art, enhancing user tactile feedback typically involved introducing mechanical damping between the rotating components. This approach aimed to improve the user experience during relative rotation. However, mechanical damping is prone to variations due to environmental factors, such as temperature, leading to inconsistent damping resistance across different settings. Consequently, this inconsistency impacts the user experience negatively. Additionally, mechanical damping requires preset resistance between the first and the second components, limiting the flexibility to adjust tactile feedback according to user preferences.

### BRIEF SUMMARY

The method introduced by the present disclosure simulates diverse tactile feedbacks during the relative rotation of the first and the second components.

One aspect presents a rotation control method that is configured to use in a rotation control device designed to drive a first component and a second component to rotate relative to each other. The method encompasses the following steps: Identifying the relative rotation angle between the first component and the second component; determining the angle range for the identified rotation angle. Notably, the first component and the second component are capable of rotating relative to each other within multiple preset angle ranges. As the rotation angle varies within a specific range, the damping between the first component and the second component is controlled to change correspondingly.

According to the method described in the above embodiment, identifying the relative rotation angle between the first component and the second component; determining the angle range for the identified rotation angle. Notably, the first component and the second component are capable of rotating relative to each other within multiple preset angle ranges. As the rotation angle varies within a specific range, the damping between the first component and the second component is controlled to change correspondingly, thereby simulating diverse usage feels for the user. This approach addresses the monotony issue encountered when the user rotates the first component and the second component relative to each other, enhancing the user experience.

### BRIEF DESCRIPTION OF THE DRAWINGS

FIG. 1 is a flowchart of a rotation control method provided by the present disclosure;

FIG. 2 is a diagram illustrating a first component and a second component according to some aspects of the disclosure;

FIG. 3 is a diagram illustrating an example of the first component and the second component according to some aspects of the disclosure;

FIG. 4 is a flowchart for identifying the relative rotation angle between the first component and the second component;

FIG. 5 is a flowchart for identifying a plurality of touch angles;

FIG. 6 is a flowchart for identifying a plurality of touch angles;

FIG. 7 is a diagram illustrating a relationship between a rotation angle and a damping according to some aspects of the disclosure;

FIG. 8 is a flowchart for controlling the corresponding change in damping between the first component and the second component and the rotation angle;

FIG. 9 is a flowchart for controlling the damping between the first component and second component to change in the same or opposite direction as the rotation angle;

FIG. 10 is a diagram illustrating the relationship between rotation angle and damping according to some aspects of the disclosure;

FIG. 11 is a diagram of the relationship between rotation angle and damping in another embodiment;

FIG. 12 is a diagram illustrating the relationship between rotation angle and damping according to some aspects of the disclosure;

FIG. 13 is a flowchart illustrating a process of a brushless motor providing damping to the rotation control device based on voltage;

FIG. 14 is a diagram illustrating a rotation control device according to some aspects of the disclosure;

FIG. 15 is a diagram illustrating a computer storage medium according to some aspects of the disclosure.

### DETAILED DESCRIPTION

The present disclosure is further elaborated upon below through specific embodiments in conjunction with the accompanying drawings. Similar elements across various embodiments adopt correlated and similar element labels. The following embodiments provide numerous detailed descriptions for a better understanding of the present application. However, those skilled in the art can readily recognize that certain features may be omitted in different scenarios or substituted with other elements, materials, or methods. In some instances, certain operations pertaining to the present application may not be shown or described in the specification to avoid obscuring the core aspects of the present application with excessive detail. For those skilled in the art, detailed descriptions of these related operations are unnecessary, as they can fully comprehend the related operations based on the descriptions in the specification and general technical knowledge in the field.

Moreover, the characteristics, operations, or features described in the specification can be combined in any suitable manner, resulting in various aspects. Additionally, the steps or actions in the method descriptions can be sequentially swapped or adjusted in ways that are evident to those skilled in the art. Hence, the various sequences in the specification and drawings are solely intended to clearly illustrate a particular aspect and do not imply a necessary sequence, unless specifically stated otherwise.

The serial numbers assigned to components in this document, such as “first” and “second,” are merely for distinguishing the described objects and do not convey any sequential or technical significance.

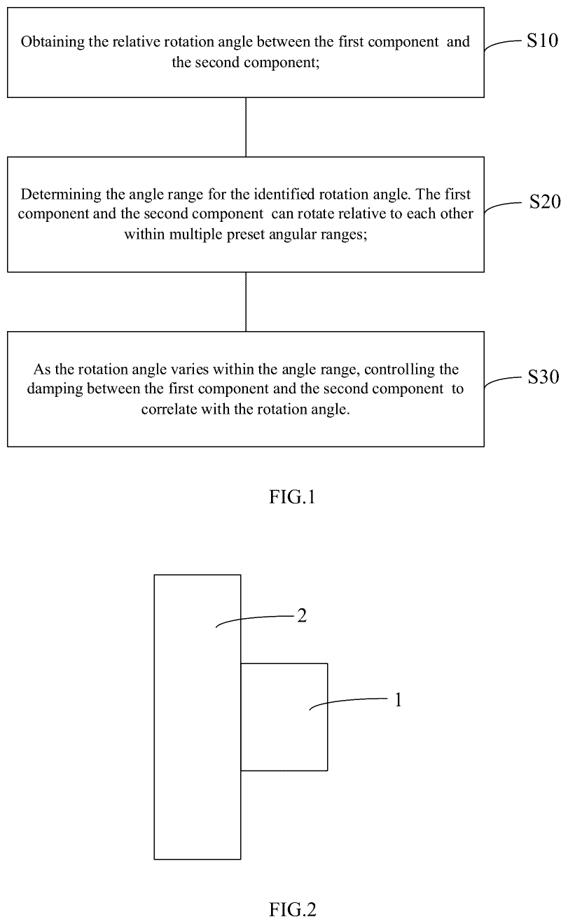

Referring to FIG. 1. The present disclosure provides a rotation control method applicable to a rotation control device used to drive the first component 1 and the second component 2 for relative rotation. The method includes:
S10: Obtaining the relative rotation angle between the first component 1 and the second component 2.

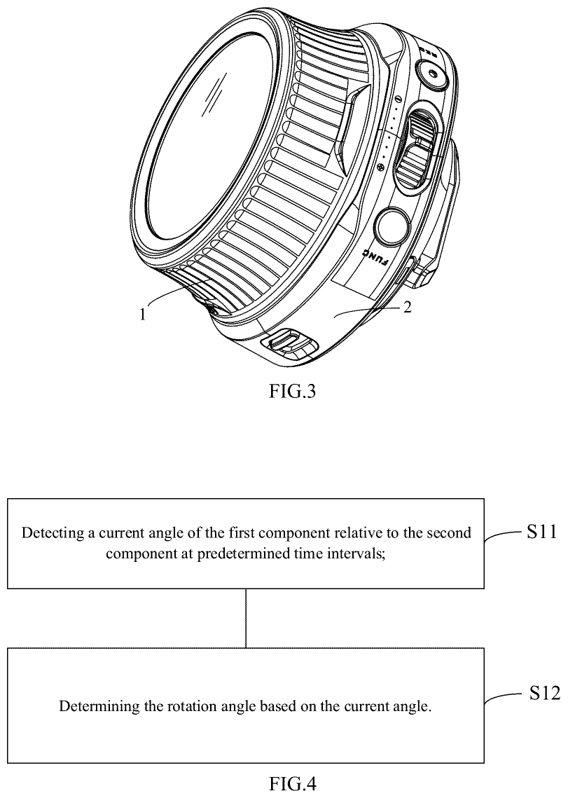

In some aspects, the first component 1 and the second component 2 can be a handwheel and an accessory body capable of relative rotation, as shown in FIGS. 2 and 3, or a knob and a fixed body on a smart device used for movement control, or a bearing and a fixed component at the connection of two robotic arms. It is understandable that any first component 1 and second component 2 capable of relative rotation are suitable for the method proposed by the present disclosure, and the present disclosure does not impose limitations on the form of the first component 1 and the second component 2.

In some aspects, obtaining the relative rotation angle between the first component 1 and the second component 2, as shown in FIG. 4, including:
S11: Detecting a current angle of the first component 1 relative to the second component 2 at predetermined time intervals;

In some aspects, the rotation control device includes a control unit, an encoding unit, and a rotation drive unit. The encoding unit converts the detected current angle of the rotation drive unit into a numerical value corresponding to the current angle recognizable by the control unit. The control unit outputs the voltage for the rotation drive unit based on the numerical value corresponding to the current angle and a preset algorithm. The rotation drive unit adjusts the damping between the first component 1 and the second component 2 to change in the same/opposite direction as the rotation angle by outputting different resistances/thrusts based on the voltage.

In some aspects, the rotation drive unit is a motor. In this aspect, the current electrical angle of the motor is detected at preset intervals, and this electrical angle is considered the current angle of the first component 1 and the second component 2. A motor converts electrical energy into mechanical energy by using an energized coil (i.e., stator winding) to generate a rotating magnetic field, which acts on the rotor to produce magnetoelectric power and rotational torque. Detecting the electrical angle of the motor involves determining the position of the rotor, which can be accomplished using position sensors such as optical encoders, magnetic encoders, and Hall sensors, or other existing methods. The present disclosure does not impose limitations in this regard.

In some aspects, the control unit can be a microcontroller unit (MCU). Regardless of whether the user rotates the first component 1 and the second component 2, the MCU detects the numerical value corresponding to the current angle returned by the encoding unit at a preset time interval, for example, once every 10 milliseconds.

S12: Determining the rotation angle based on the current angle.

In some aspects, the current angle corresponding to the numerical value from the encoding unit is considered the rotation angle, and the control unit subsequently outputs the driving voltage for the rotation drive unit based on this rotation angle and the PID algorithm. The rotation drive unit outputs different resistances/thrusts based on the driving voltage to control the damping between the first component 1 and the second component 2 within a preset angular range, thereby simulating various usage feels through this damping variation.

S20: Determining the angle range for the identified rotation angle. The first component 1 and the second component 2 can rotate relative to each other within multiple preset angular ranges.

In some aspects, the angle range for the first component 1 and the second component 2 to rotate relative to each other can include 0° to 30°, 0° to 20°, 30° to 60°, 0° to 40°, among others, without limitation.

In some aspects, multiple preset touch angles exist between the first component 1 and the second component 2, with each touch angle corresponding to an angle range. The touch angles serve to divide the corresponding angle range into the first angle interval and the second angle interval.

In some aspects, the midpoint of the angle range can be designated as the touch angle. For instance, if the angle range spans from 0° to 30°, 15° can be selected as the touch angle. Alternatively, the touch angle can be specified at other angles as per actual requirements, without any restriction herein.

In some aspects, the multiple touch angles are uniformly distributed across a total angle range, and the first component 1 and the second component 2 can rotate relative to each other within the total angle range. The total angle range includes multiple angle ranges.

In some aspects, when the total angle range covers 0° to 360°, multiple approaches can be employed to establish the touch angles. For example, if there are 12 touch angles, the total angle range can be divided into 12 segments, each spanning 30°, with a 30° interval between adjacent touch angles. Similarly, if there are 6 touch angles, the total angle range can be divided into 6 segments, each spanning 60°, with a 60° interval between adjacent touch angles. The touch angles can be determined based on practical usage requirements.

In some aspects, the procedure for obtaining multiple touch angles, as illustrated in FIG. 5, involves:
S21: Determining the total angle range for the first component 1 and the second component 2 to rotate relative to each other.
S22: Determining the number of touch angles and/or the degree of each angle range.

In some aspects, obtaining number of the touch angles involves: Receiving a user-input total angle range and a user-defined degree of the angle range; Determining number of touch angles based on the degree of the total angle range and the degree of the angle range; The number of touch angles can be calculated using the following formula:

$$L = A / N \qquad ( 1 )$$

where L represents the number of touch angles, N represents the degree of the angle range, and A represents the degree of the total angle range.

In some aspects, obtaining the degree of the angle range involves: Receiving a user-input total angle range and a user-defined number of touch angles; determining the degree of the angle range based on the total angle range and the number of touch angles; the degree of the angle range can be calculated using the following formula:

$$N = A / L \qquad ( 2 )$$

where N represents the degree of the angle range, L represents the number of touch angles, and A represents the degree of the total angle range.

In some aspects, the touch angles can be determined based on the user-input number of touch angles and the degree of the angle range. If the user inputs only the number of touch angles, the degree of the angle range can be calculated using formula (2). If the user inputs only the degree of the angle range, the number of touch angles can be calculated using formula (1).

S23: Determining the multiple touch angles based on the total angle range, number of touch angles, and/or degree of the angle range.

In some aspects, the touch angles can be determined based on the total angle range and the degree of the angle range. For example, if the user specifies a total angle range of 0° to 360° and a degree of the angle range of 60°, the number of touch angles calculated using formula (1) is 6, spanning angle ranges of 0° to 60°, 60° to 120°, . . . , and 300° to 360°. Each touch angle can then be determined based on each angle range, for example: Selecting the midpoint of each angle range, resulting in touch angles of 30°, 90°, 150°, 210°, 270°, and 330°. During application, any angle within the angle range can be selected as the touch angle as required, without any restriction herein.

In some aspects, the touch angles can be determined based on the total angle range and the number of touch angles. For example, if the user specifies a total angle range of 0° to 360° and 6 touch angles, the degree of the angle range calculated using formula (2) is 60°, spanning angle ranges of 0° to 60°, 60° to 120°, . . . , and 300° to 360°. Each touch angle can then be determined based on each angle range, for example: Selecting the midpoint of each angle range, resulting in touch angles of 30°, 90°, 150°, 210°, 270°, and 330°. During application, any angle within the angle range can be selected as the touch angle as required, without any restriction herein.

In some aspects, multiple gears can be simulated based on the total angle range, the number of touch angles, and the degree of the angle range. For example, the first gear can include 6 touch angles with a degree of the angle range of 60°, spanning angle ranges of 0° to 60°, 60° to 120°, . . . , and 300° to 360°; the second gear can include 9 touch angles with a degree of the angle range of 40°, spanning angle ranges of 0° to 40°, 40° to 80°, . . . , and 320° to 360°; and the third gear can include 12 touch angles with a degree of the angle range of 30°, spanning angle ranges of 0° to 30°, 30° to 60°, . . . , and 330° to 360°. The number of gears and their specific settings can be adjusted as actually needed. During application, multiple gears can be preset, and the touch angles can be determined based on the user's selected gear.

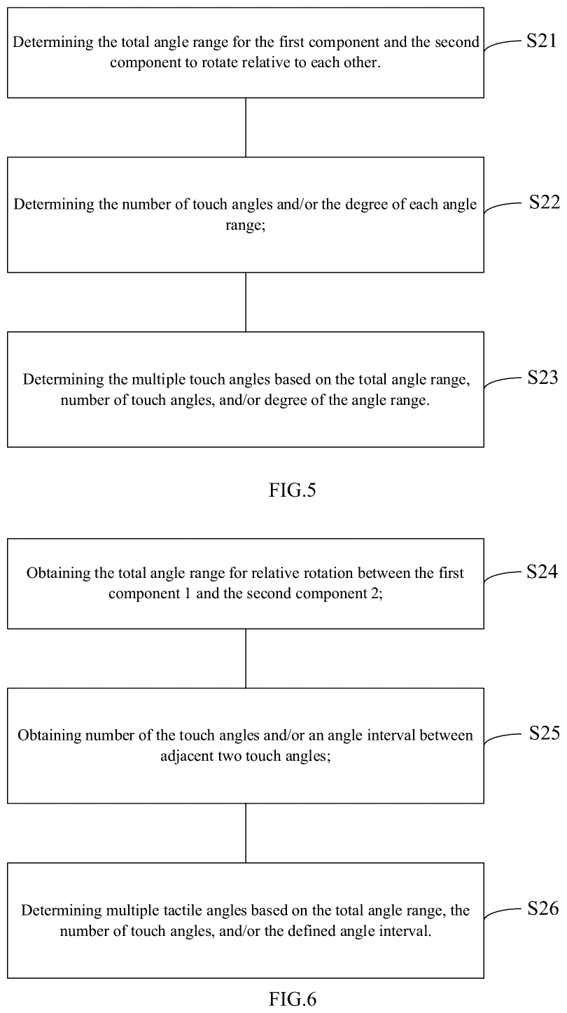

In other aspects, another method for obtaining multiple touch angles, as illustrated in FIG. 6, involves:
S24: Obtaining the total angle range for relative rotation between the first component 1 and the second component 2;
S25: Obtaining number of the touch angles and/or an angle interval between adjacent two touch angles.

In some aspects, obtaining number of the touch angles involves: Receiving a user-input total angle range and a user-defined angle interval; Determining number of touch angles based on the total angle range and the angle interval; The number of touch angles can be calculated using the following formula:

$$L = A / F \qquad ( 3 )$$

where L represents the number of touch angles, F represents the interval between adjacent touch angles, and A represents the degree of the total angle range.

In some aspects, obtaining the angle interval between two adjacent touch angles involves: Receiving a user-input total angle range and a user-defined number of touch angles; Deriving the angle interval based on the total angle range and the number of the touch angles; The interval between adjacent touch angles can be calculated using the following formula:

$$F = A / L \qquad ( 4 )$$

where F represents the interval between two adjacent touch angles, L represents the number of touch angles, and A represents the degree of the total angle range.

In some aspects, the touch angles can be determined based on user inputs for the number of touch angles and the interval. If only the number of touch angles is input, the interval can be calculated using formula (4). If only the interval is input, the number of touch angles can be calculated using formula (3).

S26: Determining multiple tactile angles based on the total angle range, the number of touch angles, and/or the defined angle interval.

In some aspects, upon receiving a total angle range of 0 to 360 degrees and an instruction to set six touch angles, the angle interval can be calculated as 60 degrees using formula (4). Consequently, the touch angles may be established at 30 degrees, 90 degrees, 150 degrees, 210 degrees, 270 degrees, and 330 degrees, respectively. The setting of touch angles can be adjusted according to application requirements and is not restrictive herein.

In other aspects, when given a total angle range of 0 to 360 degrees and an angle interval of 60 degrees, the number of touch angles can be derived as six based on formula (3). Similarly, the touch angles may be designated as 30 degrees, 90 degrees, 150 degrees, 210 degrees, 270 degrees, and 330 degrees. The setting of touch angles can be adjusted according to application requirements and is not restrictive herein.

S30: As the rotation angle varies within the angle range, controlling the damping between the first component 1 and the second component 2 to correlate with the rotation angle.

In some aspects, the angle range includes at least two angle intervals. When the rotation angle fluctuates within one angle interval, the damping between the first component 1 and the second component 2 should be modulated accordingly. Due to the damping variation within the interval where the rotation angle changes, a backlash will emerge in the other interval where the rotation angle remains constant, thereby still offering diverse user experiences. In this context, backlash refers to the gradual decrease in damping after it has reached a certain level and is no longer controlled.

To illustrate the method outlined in this aspect, consider an example where the total angle range is 0 to 360 degrees, the number of touch angles is 12, and each angle range spans 30 degrees:

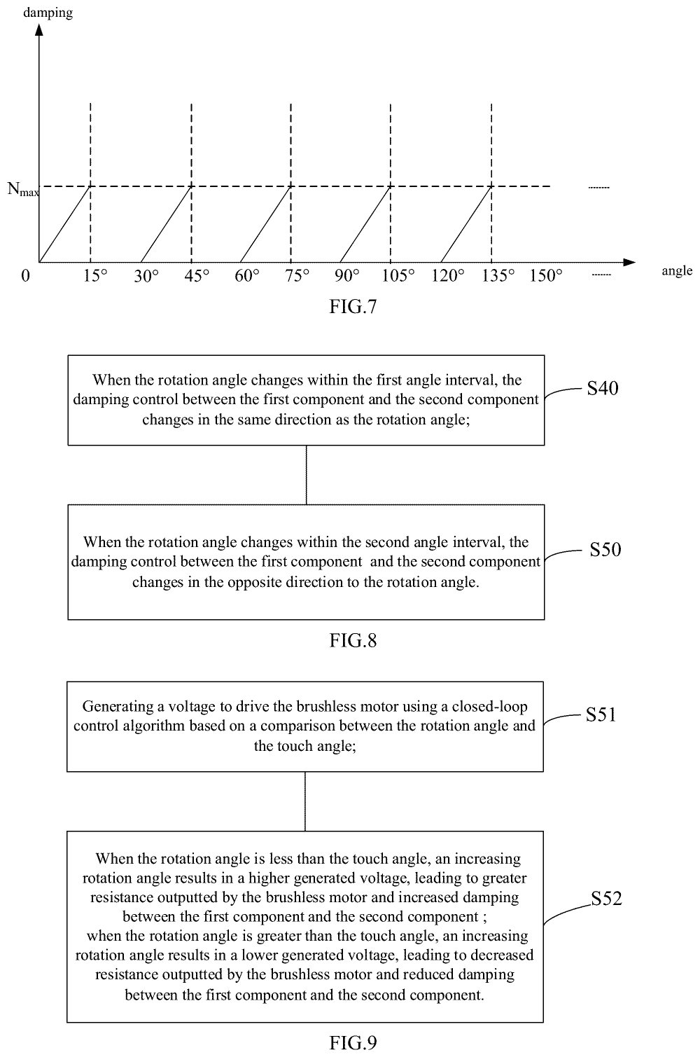

As depicted in FIG. 7 (not all touch angles are depicted), the midpoint of each angle range is designated as the touch angle. For the angle range of 0 degrees to 30 degrees, the touch angle is set at 15 degrees. This angle range is further divided into two intervals: 0 degrees to 15 degrees and 15 degrees to 30 degrees. As the rotation angle varies within the 0-to-15-degree interval, the damping between the first component 1 and the second component 2 increases with the rotation angle. In the 15-to-30-degree interval, where the rotation angle remains static, there is no need to adjust the damping between the first component 1 and the second component 2. However, due to the damping changes in the 0-to-15-degree interval, a backlash occurs in the 15-to-30-degree interval, contributing to varied user feels.

In some aspects, the angle range includes at least a first angle interval and a second angle interval. The damping control between the first component 1 and the second component 2 varies with the rotation angle, as shown in FIG. 8, as follows:
S40: When the rotation angle changes within the first angle interval, the damping control between the first component 1 and the second component 2 changes in the same direction as the rotation angle. For example, the damping can increase as the rotation angle increases withing the first angle interval.
S50: When the rotation angle changes within the second angle interval, the damping control between the first component 1 and the second component 2 changes in the opposite direction to the rotation angle. For example, the damping can decrease or remain the same as the rotation angle increases withing the second angle interval.

In some aspects, the rotation control device includes a brushless motor, and the damping control between the first component 1 and the second component 2 varies in the same or the opposite direction as the rotation angle, as shown in FIG. 9, involves:
S51: Generating a voltage to drive the brushless motor using a closed-loop control algorithm based on a comparison between the rotation angle and the touch angle.

In some aspects, the rotation control device incorporates a brushless motor including a stator, a rotor, and a control mechanism. The stator employs an iron core to enhance magnetic flux, while the rotor rotates relative to the stator. The control mechanism includes a Hall sensor, a magnetic field sensor leveraging the Hall effect, which measures magnetic field changes and converts various non-electrical, non-magnetic physical quantities, such as force, torque, pressure, stress, position, displacement, speed, acceleration, angle, angle velocity, revolution count, rotational speed, and timing of operational state changes, into electrical signals for detection and control.

In some aspects, the closed-loop control algorithm (PID) is a well-established control method widely used in equipment control and automated production. PID stands for Proportional, Integral, and Derivative coefficients, representing three control algorithms that, when combined, effectively rectify deviations in the controlled object, leading to a stable state.

In some aspects, alterations in the voltage driving the brushless motor result in changes in the magnetic field between the rotor and stator, generating different resistances or thrusts, thereby enabling the modulation of damping between the first component 1 and the second component 2.

S52: When the rotation angle is less than the touch angle, an increasing rotation angle results in a higher generated voltage, leading to greater resistance outputted by the brushless motor and increased damping between the first component 1 and the second component 2; or when the rotation angle is greater than the touch angle, an increasing rotation angle results in a lower generated voltage, leading to decreased resistance outputted by the brushless motor and reduced damping between the first component 1 and the second component 2.

The following explains the method provided by the present disclosure using an example where the total angle range spans from 0 to 360 degrees, with 12 touch angles and an angle interval of 30 degrees:

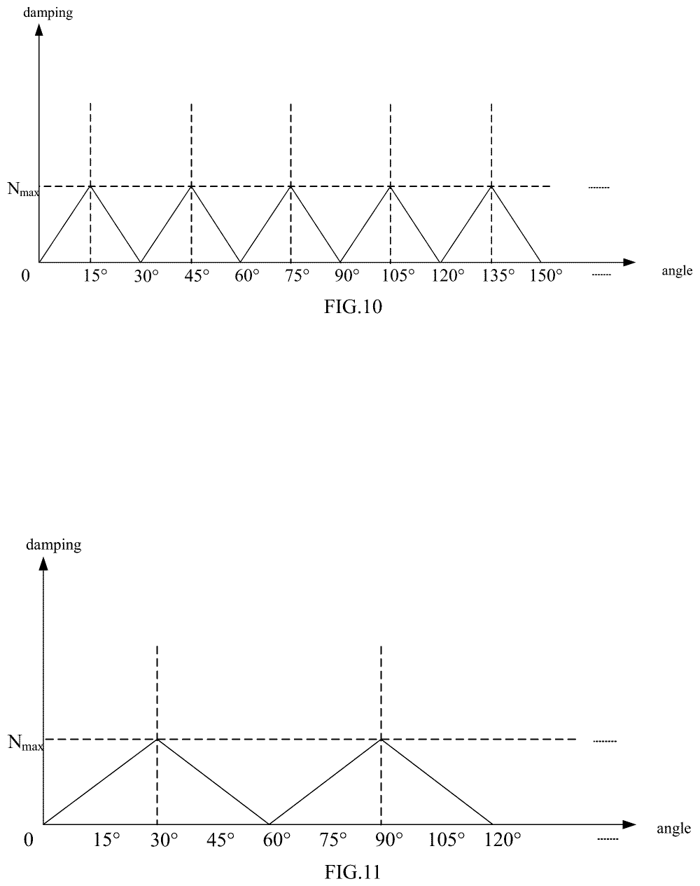

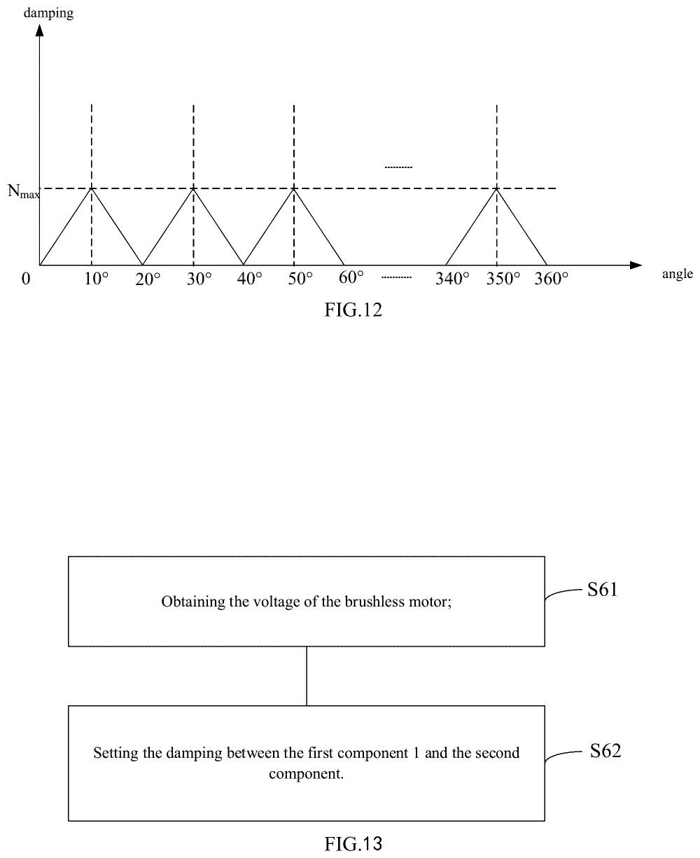

As depicted in FIG. 10 (not all touch angles are depicted), the midpoint of each angle range is designated as the touch angle. For the angle range of 0 degrees to 30 degrees, the touch angle is set at 15 degrees. When the rotation angle varies between 0 degrees and 15 degrees (i.e., below 15 degrees), the voltage driving the brushless motor increases with the rotation angle, leading to a corresponding increase in resistance generated by the motor. This controls the damping between the first component 1 and the second component 2 to intensify. Conversely, when the rotation angle varies between 15 degrees and 30 degrees (i.e., above 15 degrees), the voltage driving the brushless motor decreases with the rotation angle, resulting in a corresponding decrease in resistance generated by the motor. This controls the damping between the first component 1 and the second component 2 to diminish. This approach simulates a rich rotation feel and enhances the operational experience for users. It should be noted that this aspect uses an angle range of 0-30° as an example. In other aspects, the angle range can assume other values, which are not restrictive herein, such as 60° depicted in FIG. 11, 20° depicted in FIG. 12, and so forth.

In some aspects, the damping associated with the touch angles can be set to a maximum value, while the damping at the start and end of each angle range is set to a minimum value. For instance, the maximum damping can be set to Nₘₐₓ and the minimum damping to 0. The method presented in this aspect facilitates controlling the damping between the first component 1 and the second component 2 within a range of (0, Nₘₐₓ), further enriching the rotation feel and simulating a granular feel. The greater the number of touch angles, the more granular the feel becomes.

In some aspects, the rotation control device incorporates a brushless motor, and the brushless motor provides damping for the rotation control device based on voltage. As illustrated in FIG. 13, the method also includes:
S61: Obtaining the voltage of the brushless motor;
S62: Setting the damping between the first component 1 and the second component 2, so a higher voltage results in greater damping at a same rotation angle.

In some aspects, users can adjust the rotational force between the first component 1 and the second component 2 by configuring the limit voltage for the brushless motor. For example, at the same rotation angle, the voltage received by the brushless motor when the limit voltage is set to 10V is higher than when the limit voltage is set to 5V. Since the first component 1 and the second component 2 are rotationally connected via a brushless motor, a higher voltage intensifies the magnetic field between the rotor and stator within the brushless motor, augmenting the force between the rotor and stator and consequently the resistance outputted by the motor. This results in varied rotational forces at the same rotation angle. For instance, at a rotation angle of 20 degrees, the rotational feel is relatively stronger when the limit voltage of the brushless motor is 10V compared to when the limit voltage is 5V.

In some aspects, users are provided with settings for sub-gear parameters and force parameters. The sub-gear parameters include the total angle range, the number of touch angles, and/or the degrees of each angle range. The force parameters include the limit voltage. These two categories of parameters can be configured in combination or individually. Prior to the operational commencement of the rotation control device, the user preconfigures the sub-gear parameters and force parameters. During operation, the rotation control device periodically checks for any changes to the sub-gear parameters and/or force parameters at preset intervals. If modifications are detected, the touch angles and/or limit voltage are adjusted according to the updated sub-gear parameters and/or force parameters.

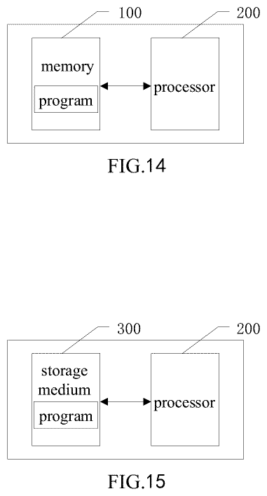

In another aspect of the present disclosure, a rotation control device is presented, as shown in FIG. 14, including: a memory 100, a processor 200, and a program stored on the memory 100 and executable by the processor 200. Upon execution of the program by the processor 200, the aforementioned method is implemented.

In another aspect of the present disclosure, a computer storage medium is presented, as shown in FIG. 15, including: a computer program stored on a storage medium 300. When executed by a processor 200, the program implements the aforementioned method.

The aforementioned detailed description with specific examples is intended to facilitate comprehension of the present disclosure and is not intended to restrict the present disclosure. Those skilled in the relevant technical field can make several straightforward deductions, modifications, or substitutions based on the principles of the disclosure.

What is claimed is:

1. A rotation control method of a rotation control device that is configured to drive a first component and a second component to rotate relative to each other, the rotation control method comprising:
obtaining a relative rotation angle between the first component and the second component;
determining an angle range for the relative rotation angle, and the first component and the second component operable to rotate relative to each other within a plurality of preset angle ranges; and
controlling a damping between the first component and the second component to change correspondingly in response to a variation of the relative rotation angle within the angle range.

2. The rotation control method according to claim 1, wherein the angle range comprises at least a first angle interval and a second angle interval;
wherein controlling the damping between the first component and the second component to change correspondingly comprises:
controlling the damping between the first component and the second component to change in a same direction as the relative rotation angle in response to the relative rotation angle changes within the first angle interval; and
controlling the damping between the first component and the second component to change in an opposite direction to the relative rotation angle in response to the relative rotation angle changes within the second angle interval.

3. The rotation control method according to claim 2, wherein a plurality of preset touch angles exist between the first component and the second component, and each touch angle corresponding to an angle range, and the touch angle is configured to divide the corresponding angle range into the first angle interval and the second angle interval.

4. The rotation control method according to claim 3, wherein the plurality of touch angles are uniformly distributed across a total angle range within which the first component and the second component are operable to rotate relative to each other; and wherein the total angle range comprises a plurality of angle ranges.

5. The rotation control method according to claim 4, further comprising:
obtaining the total angle range for relative rotation between the first component and the second component;
obtaining a number of the touch angles; and
determining the plurality of touch angles based on the total angle range and the number of touch angles.

6. The rotation control method according to claim 4, comprising:
obtaining the total angle range for relative rotation between the first component and the second component;
obtaining an angle interval between two adjacent touch angles among the plurality of touch angles; and
determining the plurality of touch angles based on the total angle range and the angle interval.

7. The rotation control method according to claim 4, comprising:
obtaining the total angle range for relative rotation between the first component and the second component;
obtaining a degree of the angle range; and
determining the plurality of touch angles based on the total angle range and the degree of the angle range.

8. The rotation control method according to claim 1, wherein the rotation control device comprises a brushless motor, and the brushless motor is configured to provide a damping for the rotation control device based on voltage; and the method further comprising:
obtaining a voltage of the brushless motor; and
setting the damping between the first component and the second component, so that a higher voltage results in greater damping at a same rotation angle.

9. The rotation control method according to claim 3, wherein the rotation control device comprises a brushless motor, and wherein controlling the damping between the first component and the second component to change correspondingly comprising:
generating a voltage to drive the brushless motor using a closed-loop control algorithm based on a comparison between the rotation angle and the touch angle;
in response to the rotation angle is less than the touch angle, an increasing rotation angle results in a higher generated voltage, leading to greater resistance outputted by the brushless motor and increased damping between the first component and the second component; and
in response to the rotation angle is greater than the touch angle, an increasing rotation angle results in a lower generated voltage, leading to decreased resistance outputted by the brushless motor and reduced damping between the first component and the second component.

10. The rotation control method according to claim 5, wherein the obtaining the number of the touch angles comprises:
obtaining a total angle range and a degree of the angle range; and
determining the number of touch angles based on the total angle range and the degree of the angle range.

11. The rotation control method according to claim 5, wherein the obtaining the number of the touch angles comprises:
obtaining the total angle range and the angle interval; and
determining the number of touch angles according to the total angle range and the angle interval.

12. The rotation control method according to claim 6, wherein the obtaining the angle interval between two adjacent touch angles, comprising:
obtaining the total angle range and the number of touch angles; and
determining the angle interval or the angle range based on the total angle range and the number of the touch angles.

13. The rotation control method according to claim 1, wherein the obtaining the relative rotation angle between the first component and the second component comprises:
detecting a current angle of the first component relative to the second component at predetermined time intervals; and
determining the rotation angle based on the current angle.

14. A rotation control device, comprising:
a memory, a processor, and a program stored in the memory that is executable by the processor, when executed, the program implements the method according to claim 1.

15. A computer storage medium, comprising:
a computer program stored in the computer storage medium, and when executed by a processor, the program carries out the method specified in claim 1.
